(19) United States
(12) Patent Application Publication
(10) Pub. No.: US 2002/0123964 A1
(43) Pub. Date: Sep. 5, 2002

(54) Payment monitoring system

(76) Inventors: Gerald Arthur Kramer, Carmel, IN (US); Matt James, Indianapolis, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 09/991,197

(22) Filed: Nov. 16, 2001

Related U.S. Application Data
(63) Continuation-in-part of application No. 09/433,168, filed on Nov. 3, 1999.

(51) Int. Cl. G06F 17/60

(52) U.S. Cl. 705/40

(57) ABSTRACT

A method of encouraging timely payments that are associated with a computer system. The method includes enabling use of the computer system based upon a comparison of a current value of the computer system and a shutoff value retrieved through a communication link from a monitoring system. The method may further include disabling use of the computer system based upon the comparison of the current value and the is greater the shutoff value.

### RELATED PROCEEDINGS

This application claims the benefit of U.S. application Ser. No. 09/433,168, entitled “Method and Apparatus for Encouraging Timely Periodic Payments Associated with a Computer System” and filed Nov. 3, 1999, the disclosure of which is hereby incorporated by reference.

### FIELD OF THE INVENTION

The present invention relates to payment monitoring systems, and more particularly to encouraging timely payments by disabling a computer system if a payment is not timely received.

### BACKGROUND

Computer systems are often purchased on time or leased over an extended period. Alternatively, computer systems are often packaged free or at a minimal cost with other products such as software licenses or with other services such as Internet services. Whether organizations collect payments for the computer system itself or for products/service packaged with the computer system, consumers often procure computer systems with little or no money down. In such cases, the organizations providing the consumers with the computer systems depend greatly upon receiving timely payments from their customers in order to remain profitable. Due to their dependence on timely payments, these organizations appreciate cost effective mechanisms which increase the likelihood of receiving timely payments from their customers.

Accordingly, a need exists for a cost effective mechanism which increases the likelihood of receiving in a timely manner payments associated with a computer system.

### SUMMARY OF THE INVENTION

The present invention addresses the above-identified need, as well as others, with a method and apparatus of disabling a computer system in the event that a current value of the computer system is less than a shutoff value retrieved from a monitoring system.

In an exemplary method of encouraging payments associated with a computer system, the computer system is provided current customer information from a database. The current customer information includes a shutoff value. The shutoff value and a current value of the computer system are compared. The computer system is enabled for use if the current value of the computer system is less than the shutoff value. In one variation the computer system is disabled for use if the current value is greater than the shutoff value. In another variation, the current customer information is provided to the computer system in response to a request for the current customer information from the computer system. The request being initiated by the computer system when a connection between the computer system and the communication link is established. In yet another variation, an extensible markup language document is sent by the computer system to an active server page.

In another exemplary embodiment, a computer readable medium for encouraging payments associated with a computer system includes a plurality of instructions which when executed by the computer system cause the computer system to compare a retrieved shutoff value and a current value of the computer system. The shutoff value is based upon a credit associated with the computer system and the current value is based upon a system clock of the computer system. The computer system is enabled for use upon determining that the retrieved shutoff value is greater than the current value. In one variation, the computer system is disabled for use if the shutoff value is less than the current value.

In yet another exemplary embodiment, a method of establishing a usage period associated with a computer system for a user includes notifying the user that a payment associated with the computer system is due by a first shutoff value. The method further includes receiving a second shutoff value. The method further includes providing the second shutoff value to the computer system through a communication link. The computer system is enabled for use if a current value of the computer system is less than the second shutoff value. In one variation, the computer system is disabled for use if the current value of the computer system is greater than the second shutoff value.

In a further exemplary embodiment, a method of encouraging payments associated with a computer system includes providing to the computer system current customer information from a database. The current customer information includes a shutoff value. The shutoff value is based upon at least one credit associated with the computer system. The shutoff value and a current value of the computer system are compared. The computer system is enabled for use based upon the comparison of the current value and the shutoff value. In one variation, the computer system is enabled for use if the current value of the computer system is less than the shutoff value and the computer system is disabled for use if the current value of the computer system is greater than the shutoff value.

### BRIEF DESCRIPTION OF THE DRAWINGS

FIG. 1 shows a simplified block diagram of computer system which incorporates various features of the present invention therein;

FIG. 2 shows a flowchart of an installation method used to install a payment assurance application upon the computer system of FIG. 1;

FIG. 3 shows a flowchart of a login service of the payment assurance application installed on the computer system of FIG. 1;

FIG. 4 shows a flowchart of a setup method of the payment assurance application used to configure the payment assurance application installed on the computer system of FIG. 1;

FIGS. 5A-5B show a flowchart of a monitoring method of the payment assurance application used to monitor activities performed on the computer system of FIG. 1;

FIG. 6 shows a flowchart of a removing method of the payment assurance application used to remove the payment assurance application from the computer system of FIG. 1.

FIG. 7 is a simplified block diagram of an exemplary payment monitoring service wherein the computer system of FIG. 1 communicates with a payment monitoring system through a communication link;

FIG. 8 is a simplified block diagram of the computer system of FIG. 1 having a network device;

FIG. 9 is a simplified block diagram representation of an exemplary payment assurance application;

FIG. 10 is a flowchart of a login service of the payment assurance application of FIG. 9;

FIG. 11 is a flowchart of the interaction between the computer system of FIG. 7 and the payment monitoring service of FIG. 7 during a communication service of payment assurance application; and

FIG. 12 is a flowchart of a bypass service of the payment assurance application of FIG. 9.

### DETAILED DESCRIPTION OF EXEMPLARY EMBODIMENTS

While the invention is susceptible to various modifications and alternative forms, exemplary embodiments thereof have been shown by way of example in the drawings and will herein be described in detail. It should be understood, however, that there is no intent to limit the invention to the particular embodiments disclosed, but on the contrary, the intention is to cover all modifications, equivalents, and alternatives falling within the spirit and scope of the invention as defined by the appended claims.

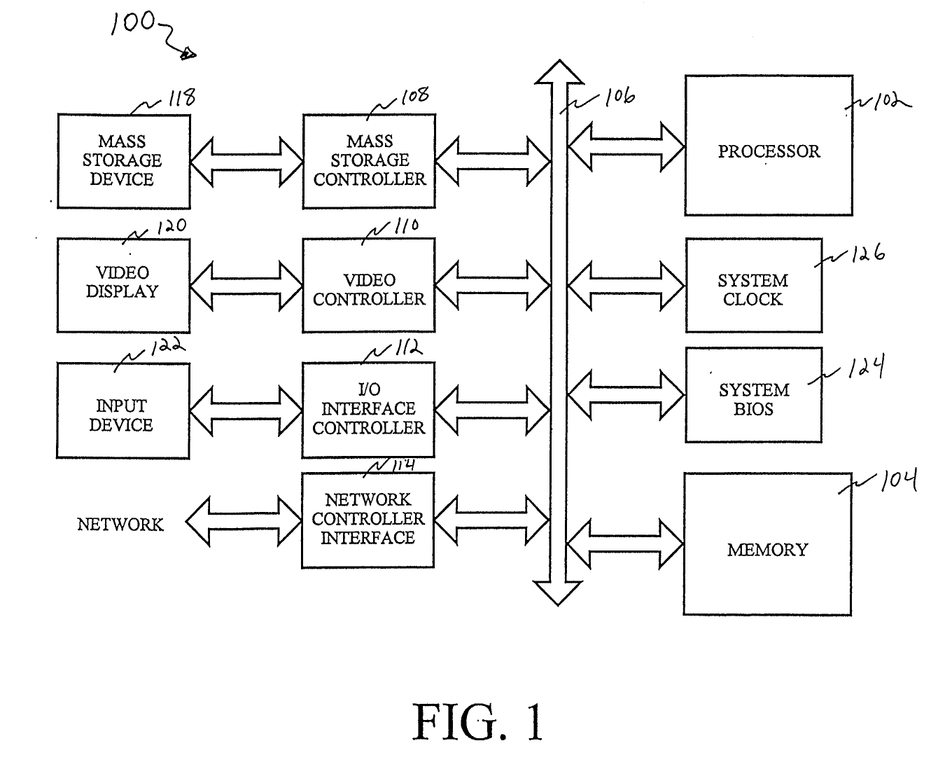

Referring now to FIG. 1, an exemplary computer system 100 is shown which incorporates various features of the present invention. Exemplary computer system 100 is generally operable to prevent use of computer system 100 in response to non-payment or a non-timely payment of a periodic fee. To this end, computer system 100 includes a processor 102, memory 104, a system bus 106, controllers 108, 110, 112, and 114, devices 118, 120, and 122, system BIOS 124, and a system clock 126. Those skilled in the art should appreciate that features of the present invention may be implemented in a properly programmed general purpose computer system or server; however, those skilled in the art should also appreciate that various features of the present invention may alternatively be implemented in a special purpose device such as Internet appliances, set-top boxes, and medical diagnostic equipment.

Processor 102 of computer system 100 is generally operable to execute software and/or firmware routines stored in memory 104. As a result of executing the software and/or firmware routines of memory 104, processor 102 controls the general operation of computer system 100 and devices 118, 120, 122 via respective controllers 108, 110, 112, and 114.

Moreover, processor 102 as a result of executing software and/or firmware routines of memory 104 is operable to prevent computer system 100 from being used if a payment is missed or is paid in an untimely manner.

Memory 104 of computer system 100 is operable to store data and instructions used by processor 102 in the course of ensuring timely payments and in the course of general execution of software applications. To this end, memory 104, in an exemplary embodiment, includes standard random access memory for storing the data and software routines needed by processor 102. However, memory 104 may alternatively include other volatile memory types such as DRAM, SDRAM, and SRAM for storing data and software routines and/or non-volatile memory types such as ROMs, PROMs, EEPROMs, and flash memory for storing data and firmware routines.

System bus 106 is generally operable to interconnect processor 102, memory 104, and controllers 108, 110, 112, and 114. To this end, system bus 106 in the exemplary embodiment includes an address bus and data bus which enable the various components of computer system 100 to communicate with one another.

Mass storage device 118 is generally operable to store data and/or software routines of computer system 100 in a non-volatile manner, and mass storage controller 108 is generally operable to provide processor 102 with an interface to the data and/or software routines stored by mass storage device 118. To this end, mass storage device 118 may include various computer readable and/or writeable media devices such as hard disk drives, floppy disk drives, CD-ROM drives, DVD-RAM drives, RAID devices, and/or Disk-On Chip devices to name a few. It should be appreciated by those skilled in the art that computer system 100 may be implemented without a mass storage device 118 and mass storage controller 108. For example, computer system 100 may be implemented with all supported applications stored in a non-volatile memory of memory 104.

Video display device 120 is operable to provide a visual display to a user of computer system 100, and video controller 110 is operable to provide processor 102 with an interface to video display device 120. To this end, video display device 120 may include CRT displays, LCD displays, and/or LED displays.

Input device 122 is operable to provide users with a mechanism for inputting information into computer system 100, and I/O interface controller 112 is operable to provide processor 102 with an interface to input device 122. To this end, input device 122 may include a mouse, keyboard, touch pad, and/or touch screen to name a few types of suitable input devices.

System BIOS 124 provides computer system 100 with basic input and output routines. In particular, system BIOS 124 provides computer system 100 with startup routines used to initialize hardware components of computer system 100. Moreover, system BIOS 124 provides computer system 100 with a hardware setup program which enables a technician to setup certain hardware components of computer system 100 such as system clock 126, and interface controllers for controlling floppy drives, hard drives, and CD-ROM drives. Furthermore, the hardware setup program of system BIOS 124 provides an interface for defining from which devices computer system 100 will attempt to boot and the order of the devices from which computer system 100 will attempt to boot.

System clock 126 essentially maintains date and time information for computer system 100. In particular, system clock 126 includes an oscillator and other hardware which in combination implement a conventional date and time clock for computer system 100. System clock 126 typically operates from battery power so that system clock 126 may continue to keep time even after computer system 100 is powered off.

Network interface controller 114 is generally operable to provide processor 102 with an interface to devices coupled to a network (not shown) such as a LAN or the Internet. To this end, the network interface controller 114 may include an analog modem, an ISDN modem, a DSL interface, an Ethernet controller, and/or other wired/wireless communication interfaces.

Exemplary Embodiment A

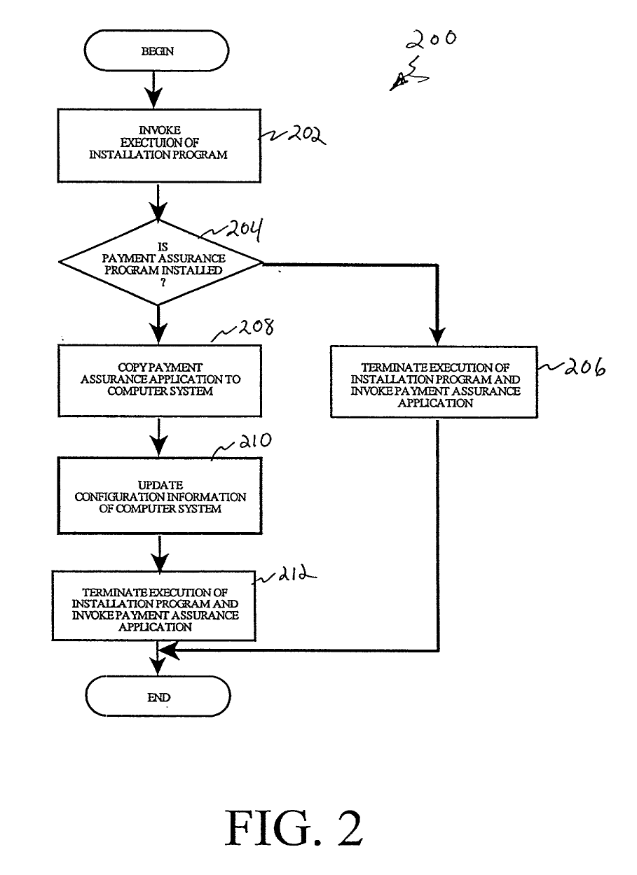

Computer system 100 in exemplary embodiment A executes a payment assurance application which is depicted in detail in FIGS. 2-6. In general, the payment assurance application configures computer system 100 to prevent use of computer system 100 if a periodic payment has not been made in a timely manner. To this end, the payment assurance application attempts to configure exemplary computer system 100 to provide a computing environment which allows a user to use computer system 100 with minimal interference while at the same time making it difficult for the average user to circumvent the protection provided by the payment assurance application. Similar to locks on an automobile, the obstacles presented to an individual are sufficient to deter most into compliance; however, sophisticated individuals determined to gain unwarranted access at all costs are likely to succeed in finding a way to circumvent the obstacles. With this in mind, design choices were made during the development of the exemplary payment assurance application to lessen either (i) the amount of interference and intrusiveness caused by the payment assurance application, or (ii) the complexity and expense associated with implementing the payment assurance application, at the expense of the level of security provided by the payment assurance application. Accordingly, those skilled in the art may chose to provide additional or alternative safeguards than those described herein.

Shown in FIG. 2 is a flowchart of an exemplary installation method 200 for installing the payment assurance application upon exemplary computer system 100 of FIG. 1. In general, installation method 200 causes computer system 100 to copy an exemplary payment assurance application to computer system 100 and perform some initial configuration of the payment assurance application. To this end, the computer system in step 202 invokes execution of an installation program stored on a computer readable medium such as a CD-ROM disc or a floppy disk. As a result of executing the installation program, computer system 100 in step 204 determines whether the payment assurance application is already installed on computer system 100. To this end, computer system 100 may make this determination based upon several known techniques such as determining whether certain executables are available to computer system 100 and/or determining whether certain configuration parameters are set in computer system 100.

If computer system 100 in step 204 determines that the payment assurance application is already installed on computer system 100, then computer system 100 in step 206 terminates execution of the installation program and causes computer system 100 to invoke execution of the payment assurance application. In particular, computer system 100 in an exemplary embodiment invokes execution of reboot operation which causes computer system 100 to execute a shutdown process and subsequent a system startup process that invokes the payment assurance application.

However, if computer system 100 in step 204 determines that the payment assurance application is not installed on computer system 100, then computer system 100 installs the payment assurance application on computer system 100. To this end, computer system 100 in step 208 copies the payment assurance application to computer system 100 in a persistent manner. For example, in an exemplary embodiment, computer system 100 copies the payment assurance application to mass storage device 118. Those skilled in the art should appreciate that depending upon the implementation of the payment assurance application, computer system 100 may need to copy one or more files. For example, the payment assurance application may be implemented as a single executable that does not require any other files, or the payment assurance application may be implemented as one or more executable files that are dynamically linked to several library files and that each rely upon various data and configuration files for proper execution.

Besides causing computer system 100 to copy the payment assurance application to computer system 100 in a persistent manner, the installation program further causes computer system 100 in step 210 to update configuration information so that during a system startup process computer system 100 invokes execution of a login service provided by the payment assurance application. While various known techniques may be used to configure computer system 100 to invoke upon system startup the login service of the payment assurance application, the installation program, in an exemplary Microsoft™ Windows™ embodiment of the payment assurance application, causes computer system 100 to add appropriate references to the payment assurance application in the “Run” key and the “RunOnce” key of the Registry Database. In particular, the entry in the “RunOnce” causes computer system 100 to invoke the login service of the payment assurance application upon system startup of the computer system 100 and prevents computer system 100 from completing the startup process until execution of the payment assurance application is terminated. Moreover, since programs referenced by the “RunOnce” key in a Microsoft™ Windows™ environment are executed early in the system startup process, the payment assurance application configures computer system 100 to implement features of the payment assurance application before a user may input commands to computer system 100. For example, in an exemplary Microsoft™ Windows™ embodiment, the program assurance application causes computer system 100 to disable certain keys and/or key combinations such as the “Alt-Tab”, “F8”, “Ctrl-Esc”, “Alt-F4”, and “Ctrl-Alt-Delete” which may otherwise enable a user to circumvent the program assurance application by causing computer system 100 to switch to another executing process or causing computer system 100 to terminate execution of the programs assurance program.

Another advantage of causing the payment assurance application to be executed via the entries in the “Run” key and “RunOnce” key is that these entries cause computer system 100 to execute the payment assurance application as a service. In Microsoft™ Windows™ environments, services are not listed by the Task Manager of Microsoft™ Windows™ operating systems. The Task Manager of the Microsoft™ Windows™ operating systems provides users with an interface to terminate processes; however, since the payment assurance application is executed as a non-listed service, users are prevented from simply terminating the payment assurance application via the Task Manager in order to circumvent the protections provided by the payment assurance application. The installation program then in step 210 causes computer system 100 to reboot in order to force computer system 100 through the system startup process. Due to the above installation of the payment assurance application, computer system 100 will begin execution of the payment assurance application as part of the system startup process.

The installation program then in step 212 causes computer system 100 to terminate execution of the installation program and to invoke execution of the payment assurance application. To this end, computer system 100 invokes a reboot operation that causes computer system 100 to terminate all processes and to subsequently invoke execution of the payment assurance application as part of a startup operation. As a result of invoking the reboot operation, computer system 100 terminates all executing processes and then invokes a system startup process. Since the above installation of the payment assurance program configured computer system 100 to invoke execution of the login service of the payment assurance program upon system startup, rebooting computer system 100 in step 212 effectively invokes the payment assurance application and the protections associated with the payment assurance application.

While not part of the exemplary installation program, a technician who is configuring computer system 100 may perform further actions in order to enhance the protection provided by the payment assurance application. In particular, the technician may configure computer system 100 via the setup program of system BIOS 124 to attempt to boot from mass storage device 118 before attempting to boot from another device. In this manner, the technician prevents a user from circumventing the payment assurance application by simply booting the computer system 100 from a removable media such as a floppy disk or a CD-ROM disc. Furthermore, the technician may password protect the setup program of the system BIOS 124 to prevent users from circumventing the payment assurance application by reconfiguring computer system 100 to attempt to boot from a removable media before attempting to boot from mass storage device 118.

Moreover, while the exemplary payment assurance application was described above as being installed on mass storage device 118, in one variation the payment assurance application may take alternative forms which would not require installing the payment assurance application to mass storage device 118. For example, the payment assurance application may be implemented in non-volatile memory of computer system 100 and/or as part of system BIOS 124. Furthermore, in such implementations, computer system 100 may not need to execute an installation program in order to install the payment assurance application since the functionality of the payment assurance application is already integrated into the hardware components of computer system 100.

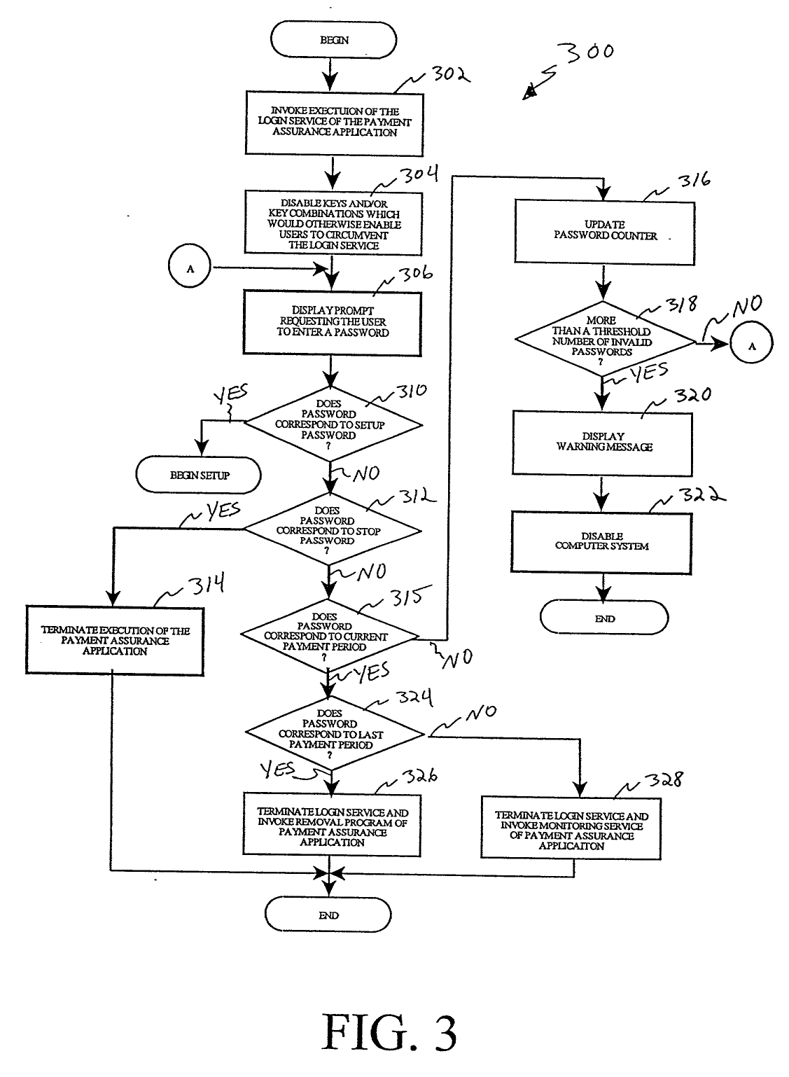

After being configured with the payment assurance application, computer system 100 in step 302 of FIG. 3 automatically executes a login service of the payment assurance program as part of the startup process. The exemplary login service of the payment assurance application causes computer system 100 in step 304 to disable certain keys and/or key combinations of the keyboard which would enable a user to switch to another process or prematurely terminate the payment assurance program. For example, in the Microsoft™ Windows™ environment, the exemplary assurance application causes the computer system 100 to disable the “Alt-Tab”, “F8”, “Ctrl-Esc”, “Alt-F4”, and “Ctrl-Alt-Delete” keys and/or key combinations which may otherwise enable users to circumvent the login service of the payment assurance application by causing computer system 100 to switch to another executing process or causing computer system 100 to prematurely terminate the execution of the payment assurance application.

The login service of the payment assurance application causes computer system 100 in step 306 to display upon video display 120 a prompt for a password. In particular, computer system 100 in an exemplary embodiment displays a dialog box in which a user may type a password. Each time a periodic payment is received by the organization responsible for monitoring payments associated with computer system 100, the organization supplies the user via mail, e-mail, or some other mechanism, the password associated with the next payment period. Accordingly, if the user makes the periodic payments in a timely manner, then the user will obtain the passwords for each payment period in a timely fashion. As will be apparent from the following description, the user will be effectively prevented from using computer system 100 if the user does not have the appropriate password for the current payment period. Accordingly, if the user does not want to be prevented from using computer system 100, then the user will be motivated to make the period payments associated with computer system 100 in a timely manner.

Upon receiving a password, the login service of the payment assurance application causes computer system 100 in step 310 to determine whether the entered password corresponds to a setup password for the payment assurance application. Computer system 100 may utilize several known techniques for determining whether the entered password corresponds to the setup password for the payment assurance application. For example, computer system 100 may determine whether the entered password corresponds to the setup password by comparing the entered password to a setup password that is hard-coded into the payment assurance application. Alternatively, computer system 100 may determine whether the entered password corresponds to the setup password based upon an encrypted setup password which may be stored on mass storage device 118, non-volatile memory of computer system 100, or hard-coded into the payment assurance application.

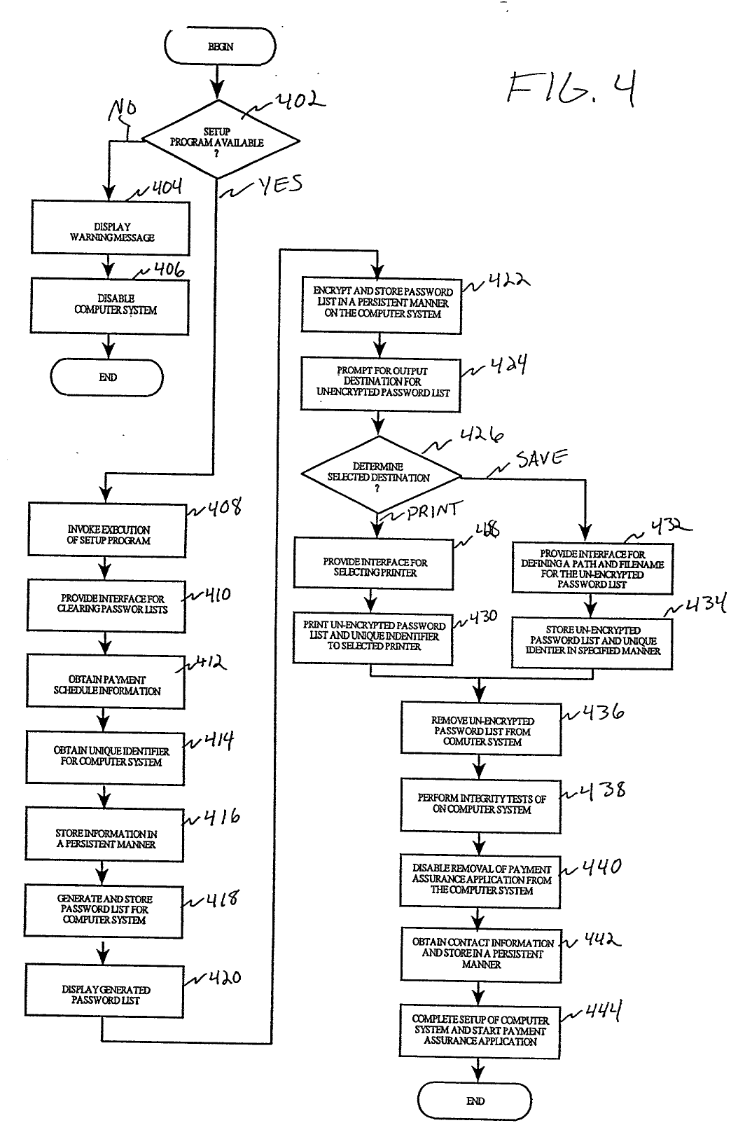

If computer system 100 in step 310 determines that the user entered the setup password, then computer system 100 proceeds to step 402 of a setup method 400 depicted in FIG. 4. However, if computer system 100 in step 310 determines that the user did not enter the setup password, then computer system 100 in step 312 determines whether the user entered the stop program password. To this end, computer system 100 may utilize several known techniques for determining whether the entered password corresponds to the stop program password for the payment assurance application. For example, computer system 100 may determine whether the entered password corresponds to the stop program password by comparing the entered password to a stop program password that is hard-coded into the payment assurance application. Alternatively, computer system 100 may determine whether the entered password corresponds to the stop program password based upon an encrypted stop program password which may be stored on mass storage device 118, non-volatile memory of computer system 100, or hard-coded into the payment assurance application.

If computer system 100 in step 312 determines that the user entered the stop program password, then computer system 100 in step 314 terminates execution of the payment assurance application. As a result of terminating execution of the payment assurance application, a user of computer system 100 regains complete access to computer system 100. A technician which is attempting to reconfigure a computer system 100 on which the payment assurance application is installed may find it advantageous to cease execution of the payment assurance application in order to regain complete control of the computer system. Assuming that the technician or another user does not reconfigure computer system 100 to do otherwise, the stop program password does not prevent computer system 100 from executing the payment assurance application as part of the startup process. In other words, the stop program password merely terminates current execution of the payment assurance application and does not effect future execution of the payment assurance application.

However, if computer system 100 in step 312 determines that the user did not enter the stop program password, then computer system 100 in step 315 determines whether the user entered the password for the current payment period. To this end, the exemplary payment assurance application causes computer system 100 to make this determination based upon the current system time and an encrypted password set stored in the Registry Database of the Microsoft™ Windows™ environment.

If computer system 100 determines in step 315 that the user did not enter the correct password for the current installment period, then computer system 100 in step 316 updates a password counter used to track the number of incorrect passwords received by computer system 100 since the system startup process. Based upon the password counter, computer system 100 in step 318 determines whether computer system 100 has received more than a threshold number (e.g. 3) of incorrect passwords. If computer system 100 determines that not more than the threshold number of incorrect passwords have been received, then computer system 100 returns to step 306 in order to receive another password.

However, if computer system 100 determines in step 318 that more than the threshold number of incorrect passwords have been received, then the payment assurance application causes computer system 100 to display a warning message in step 320. In particular, the warning message, in an exemplary embodiment, provides the user with an indication that the password is incorrect for the current payment period and provides the user with contact information for an organization from which the user may obtain the correct password. After displaying the warning message for a few seconds, computer system 100 in step 322 disables further use of computer system 100. To this end, computer system 100 in an exemplary embodiment invokes a shutdown operation which causes computer system 100 to terminate all running processes. However, those skilled in the art should appreciate that computer system 100 may utilize other techniques for disabling computer system 100. For example, computer system 100 may be disabled by preventing any further execution of user processes.

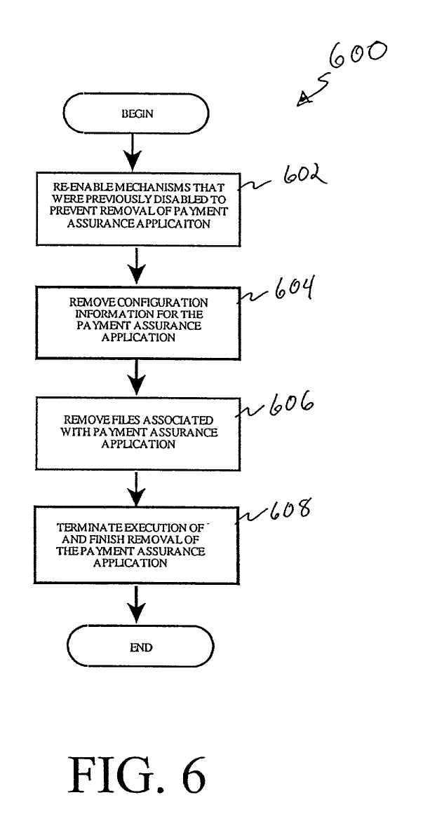

If computer system 100 determines in step 315 that the user entered the correct password for the current payment period, then computer system 100 in step 324 determines whether the user has made the last payment. To this end, computer system 100 determines based upon the received password and the encrypted password list for computer system 100 whether the received password corresponds to the password for the last payment period. If computer system 100 in step 324 determines that the user has made the last payment, then computer system 100 in step 326 completes the startup process and invokes execution of the program removal method 600 depicted in FIG. 6.

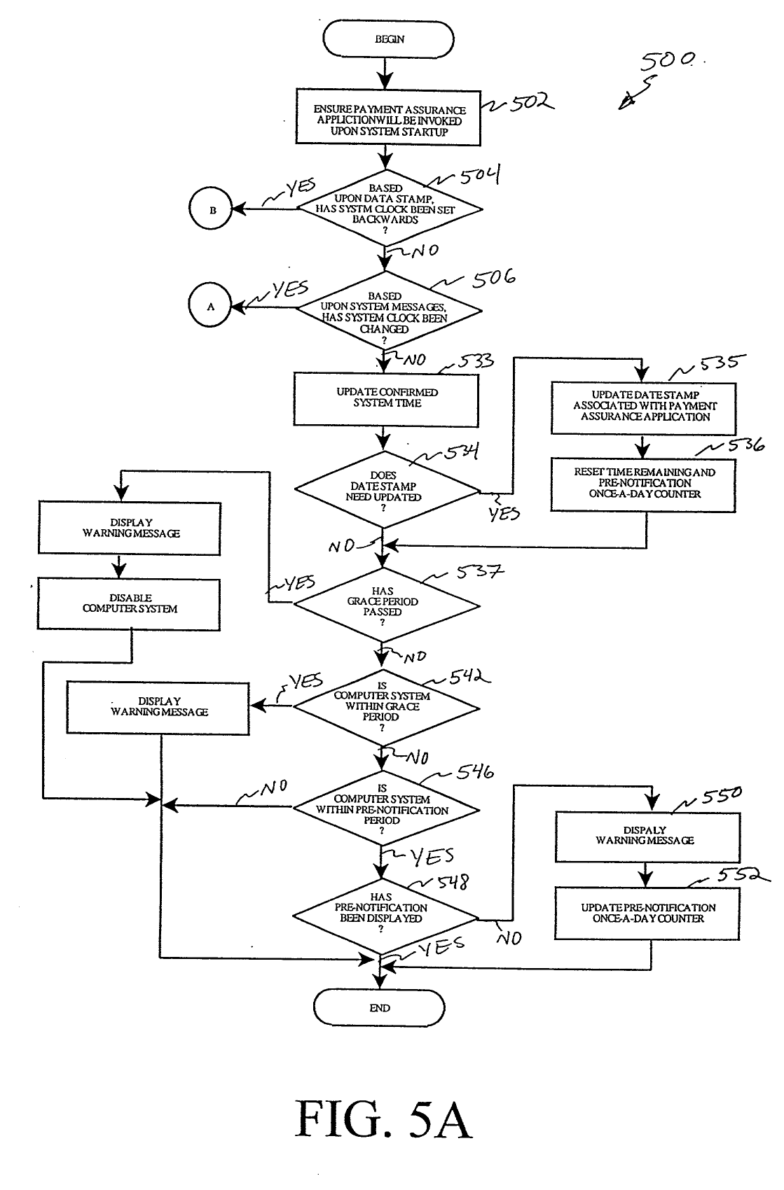

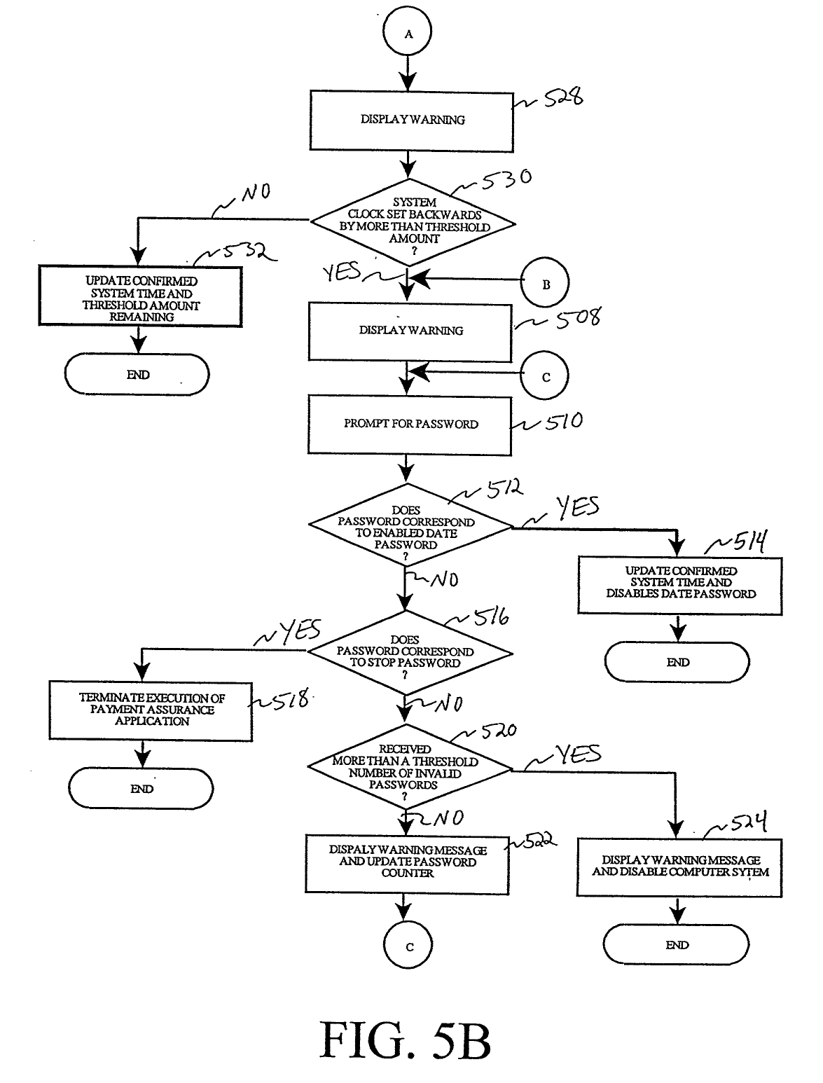

If computer system 100, however, determines that the received password is not the last password of the encrypted password set, then the payment assurance application causes computer system 100 in step 328 to complete the system startup process and invoke a monitoring service of the payment assurance application. To this end, computer system 100 in an exemplary embodiment updates the “Run” key of the Registry Database to ensure that “Run” key of the Registry Database includes a proper reference to invoke the monitoring service of payment assurance application. After updating the Registry Database, computer system 100 terminates the current execution of the payment assurance application in order to enable computer system 100 to complete the system startup procedure. Termination of the payment assurance application causes computer system 100 to delete the reference to the login service of the payment assurance application from the “RunOnce” key of the Registry Database. Furthermore, as a result of the entry in the “Run” key, computer system 100 invokes execution of the monitoring service of the payment assurance application depicted in FIGS. 5A-5B upon termination of the login service.

Referring now to FIG. 4, there is depicted a flowchart for a setup method 400 implemented by computer system 100 in response to determining in step 310 that the setup password was received. In general, computer system 100 during setup method 400 provides a technician with a graphical user interface that enables the technician to configure computer system 100 for a particular payment schedule. To this end, computer system 100 in step 402 determines whether the setup program is available. In an exemplary embodiment, the payment assurance application is pre-configured to execute the setup program from a particular location on a floppy drive. Accordingly, computer system 100 determines whether the setup program is accessible from the particular location. If computer system 100 determines that the setup program is not accessible, then computer system 100 in step 404 displays a warning message that indicates the user performed a prohibited action. After displaying the warning message for a few seconds, computer system 100 in step 406 disables use of computer system 100. To this end, computer system 100 in an exemplary embodiment invokes a shutdown operation which causes computer system 100 to terminate all executing processes.

However, if computer system 100 determines in step 402 that the setup program is accessible, then computer system 100 in step 408 invokes execution of the setup program. By implementing the setup program as a separate program, the program assurance application introduces additional obstacles for a user who is intent on circumventing the payment assurance application. In particular, a user intent on circumventing the payment assurance application via the setup program would need not only the correct setup password but would also need a copy of the setup program.

In response to executing the setup program, computer system 100 in step 410 provides a graphical user interface from which a technician may request computer system 100 to clear any prior password lists installed on computer system 100. For example, computer system 100 may detect whether the technician has activated a “Clear Password” button of the graphical user interface and clear any encrypted passwords lists by deleting appropriate keys from the Registry Database of computer system 100.

Computer system 100 then in step 412 obtains information concerning the payment schedule. In an exemplary embodiment, computer system 100 provides a graphical user interface from which a technician may define the length of the payment schedule (e.g. 36 months, 102 weeks, etc.); the grace period for receiving each periodic payment (e.g. 10 days); the date the first payment is due (e.g. Jan. 1, 2000); and the day each recurring payment is due (e.g. every Friday, the first of the month, the fifth of the month, etc.). Moreover, computer system 100 in step 414 obtains a unique identifier for computer system 100 being configured. In particular, computer system 100 in an exemplary embodiment provides a graphical user interface from which a technician may enter a unique identifier such as the customer's telephone number. By assigning a unique identifier to computer system 100, an organization may easily associate a password list with the appropriate computer system.

Computer system 100 in step 416 stores the collected information in a secure and persistent manner. To this end, computer system 100 in an exemplary embodiment encrypts the collected information with the Blowfish encryption algorithm and stores the encrypted information in keys of the Registry Database that is stored on mass storage device 118. Computer system 100 alternatively may encrypt the collected information with other algorithms and store the collected information on other non-volatile media such as EEPROMs or flash memory devices. Furthermore, in computing environments that provide built in security measures such file permissions and file ownership, computer system 100 may store the collected information in a non-encrypted manner in files that are in accessible to users of computer system 100.

After storing the collected information, computer system 100 in step 418 generates a password list for computer system 100 and saves the password list in a persistent manner. More specifically, computer system 100 in an exemplary embodiment generates a different password for each payment period and three additional date passwords that enable a user to update system clock 126 of computer system 100, and stores the generated password list in a file on mass storage device 118. Then, computer system 100 in step 420 displays upon video display 120 each password of the generated password list. As a result of displaying the password list, the technician may visual verify that appropriate passwords were generated for computer system 100.

Computer system 100 in step 422 encrypts each generated password with an encryption algorithm such as the DES algorithm, the IDEA algorithm, the RC4 algorithm, or the Blowfish algorithm, and stores the encrypted password list in a persistent manner. In particular, in an exemplary embodiment, computer system 100 stores the encrypted password list in CLSID keys of the Registry Database without associating meaningful descriptions to the keys. Since the Registry Database typically includes a large number of CLSID keys without highly meaningful descriptions, users in search of the passwords will have a difficult time identifying which CLSID keys of the Registry Database store the encrypted password list for computer system 100. Moreover, since the passwords are stored in CLSID keys in an encrypted manner, average users would find it very difficult to decrypt the passwords even if they were able to determine in which CLSID keys the encrypted passwords were stored.

Computer system 100 in step 424 prompts the technician via the graphical user interface to indicate whether computer system 100 should print the password list or save the password list to disk. If computer system 100 determines in step 426 that the technician chose to have the password list printed, then computer system 100 in step 428 provides the technician with an interface for choosing a particular printer and causing the selected printer to print the password list along with the unique computer name assigned to computer system 100. In response to choosing a particular printer, computer system 100 in step 430 prints the password list for computer system 100 along with the unique identifier assigned to computer system 100.

However, if computer system 100 in step 426 determines that the technician chose to have the password list saved to disk, then computer system 100 in step 432 provides the technician with a graphical user interface for defining a path and a filename to which computer system 100 is to save the password list and unique identifier for computer system 100. In response to defining the path and filename, the computer system in step 434 saves the password list and unique identifier to a file having the defined filename at a location defined by the path. Saving the password list and unique identifier to disk facilitates additional information retrieval and security functionality not provided by printing the password list and unique identifier. In particular, saved password lists and associated identifiers may be integrated with a database system to provide quick retrieval of passwords for a large inventory of computer systems. Moreover, the saved password lists may be encrypted and password protected in order to secure access to the password lists.

After printing or saving the password list and unique identifier, computer system 100 in step 436 removes the un-encrypted password list from computer system 100. More specifically, computer system 100 in an exemplary embodiment deletes a file containing the un-encrypted password list from computer system 100 in such a manner which prevents undelete utilities from recovering the file. Removing the un-encrypted password list from computer system 100 prevents users from simply locating and reading the un-encrypted password list in order to obtain the proper password for each payment period of the payment schedule.

Computer system 100 then in step 438 tests the integrity of computer system 100 and the configuration of the payment assurance application. To this end, computer system 100 in an exemplary embodiment tests the integrity of mass storage device 118, the integrity of the Registry Database, and the integrity of the decryption algorithms. For example, computer system 100 in an exemplary embodiment verifies that the encrypted passwords can be successfully retrieved from the Registry Database that is stored on mass storage device 118 and that the retrieved passwords can be successfully decrypted. Moreover, computer system 100 in an exemplary embodiment causes the first password to be displayed upon video display 120 in both its encrypted form and its decrypted form so that the technician configuring computer system 100 may make a visual verification that computer system 100 can successfully retrieve and decrypt passwords of the password list.

Computer system 100 then in step 440 disables removal of the payment assurance application from computer system 100. In an exemplary implementation of the payment assurance application, the login service and monitoring service are implemented with a single executable file. After being powered-up, computer system 100 either is executing the executable file for the payment assurance program or is not operable to receive user input. Microsoft™ Windows™ operating systems do not allow users to delete files which are currently being accessed by the operating system such as the executable file for the payment assurance program. Accordingly, since from the users standpoint, computer system 100 is constantly executing the executable file for the payment assurance application, the Microsoft™ Windows™ operating systems inherently prevents the user from removing the executable file for the payment assurance application from mass storage device 118.

A user may, however, attempt to reformat mass storage device 118 in order to remove the payment assurance application from mass storage device 118. In order to prevent removal of the payment assurance application from computer system 100 via reformatting mass storage device 118, computer system 100 disables the format command for MS-DOS commandline of the Microsoft™ Windows™ operating system. In particular, computer system 100 encrypts the executable file of the MS-DOS format command, renames the encrypted executable file to a non-descriptive name, and moves the renamed and encrypted executable file to a non-standard location on mass storage device 118. As a result of the above changes to the format command, average users should have a difficult time locating and executing the format command of the Microsoft™ Windows™ operating system while at the same time maintaining a copy of the format command on mass storage device 118 so that the format command may be automatically re-enabled after the user makes the last payment of the payment schedule.

As a result of disabling the format command of the Microsoft™ Windows™ operating system, a user cannot simply execute the format command stored upon mass storage device 118 in order to reformat mass storage device 118 and circumvent the payment assurance application. However, a user is still able to format removable media such as floppy disks via a the Microsoft™ Windows™ format interface. The Microsoft™ Windows™ format interface inherently forbids a user from reformatting the disk partition from which the Microsoft™ Windows™ operating system booted. Accordingly, the combination, of disabling the Microsoft™ Windows™ format command and functionality inherent to Microsoft™ Windows™ format interface, prevents a user of computer system 100 from circumventing the payment assurance application by reformatting mass storage device 118 while at the same time permitting the user to format other storage media such as floppy disks or a second hard drive.

The computer system then in step 442 requests the technician to enter contact information such as a business name and phone number and saves the received contact information in a persistent manner. The payment assurance application utilizes the supplied information to provide a user of computer system 100 with contact information in case the user encounters problems with computer system 100, needs to obtain a password, has questions concerning computer system 100, or has questions concerning the payment schedule.

In step 444, computer system 100 terminates execution of the setup program and forces execution of the payment assurance application. To this end, computer system 100 in one variation of exemplary embodiment A invokes execution of a reboot operation which causes computer system 100 to terminate all executing processes and to invoke the payment assurance application as part of a subsequent startup operation. As a result of executing the reboot operation, computer system 100 executes a shutdown process which causes computer system 100 to terminate execution of all executing processes and to subsequently invoke a system startup process. Accordingly, after computer system 100 completes execution of setup method 400, computer system 100 will automatically execute the payment assurance program in accordance with the supplied payment schedule information and associated password list.

In general, once the user has entered the proper password for the current payment period, computer system 100 essentially invokes a monitoring service of the payment assurance application that causes computer system 100 to periodically verify that the user has not perform certain operations that could circumvent the payment assurance application. Referring now to FIGS. 5A-5B, there is depicted a monitoring method 500 which computer system 100 executes on a periodic basis such as every 500 milliseconds. However, those skilled in the art should appreciate that monitoring method 500 may be implemented in various other manners which may include multiple interrupt service routines, polling routines, hardware timers, and/or software timers. For example, an exemplary embodiment of monitoring method 500 utilizes a 500 millisecond timer that upon expiration causes computer system 100 to verify a first set of conditions and a 1000 millisecond timer that upon expiration causes computer system 100 to verify a second set of conditions.

Upon each periodic execution of monitoring method 500, computer system 100 in step 502 ensures that execution of the payment assurance application will be invoked as part of the system startup process. To this end, computer system 100 in an exemplary embodiment updates the “Run” and “RunOnce” keys of the Registry Database with entries that properly reference the monitoring service and login service of the payment assurance application, respectively. In this manner, computer system 100 effectively prevents a user from configuring computer system 100 to not invoke execution of the payment assurance application upon system startup. In particular, assuming computer system 100 updates the “Run” and “RunOnce” keys of the Registry Database on a relatively short interval such as 500 millisecond, even if the user were to delete or alter the entries of the Registry Database the periodic execution of monitoring method 500 would effectively update the “Run” and “RunOnce” entries to proper values before the user could terminate the monitoring service by restarting or powering-down computer system 100.

One manner by which users may attempt to circumvent the payment assurance application is by setting system clock 126 backwards to a date prior to an overdue payment date. Users may utilizes various different techniques in an attempt to set system clock 126. Accordingly, computer system 100 in an exemplary embodiment performs several tests to ensure that the user has not attempted to change system clock 126 of computer system 100. In particular, computer system 100 in step 504 determines based upon the date as indicated by system clock 126 and a date stamp associated with the program assurance application whether system clock 126 has been set backwards. More specifically, computer system 100 determines that system clock 126 has been set backwards if the date indicated by system clock 126 is earlier then the date indicated by the date stamp of the program assurance application.

If computer system 100 determines in step 504 that system clock 126 has been set backwards, then the computer system in step 508 displays a warning message that indicates changes to system clock 126 are prohibited and provides contact information for an organization from which a password that re-enables computer system 100 may be obtained.

After displaying the warning message for a few seconds, computer system 100 in step 510 prompts the user for a password. If computer system 100 determines in step 512 that a user entered a proper date password, then computer system 100 in step 514 updates a confirmed system time for computer system 100, disables the entered date password from being used again, and exits monitoring method 500 until the next periodic execution of monitoring method 500. To this end, computer system 100 determines that the received password is a proper date password if the entered password corresponds to a non-disabled date password of the password list. Moreover, upon determining that the received password is a proper date password, computer system 100 in an exemplary embodiment sets a flag associated with the date password that disables the date password from being used again. Furthermore, computer system 100 in an exemplary embodiment stores the confirmed system time of system clock 126 in a key of the Registry Database in order to maintain a persistent copy of the last confirmed system time.

However, if computer system 100 determines that a user did not enter a proper date password, then computer system 100 determines in step 516 whether the user entered the stop password. If computer system 100 determines that the user entered the stop password, then computer system 100 in step 518 terminates the current execution of the program assurance application in a manner similar to above step 314 of FIG. 3.

If computer system 100 determines in step 516 that the user did not enter the stop password, then computer system 100 in step 520 determines whether more than a threshold number (e.g. 3) of invalid passwords have been entered. If computer system 100 determines that more than the threshold number of invalid passwords have not been entered, then computer system 100 in step 522 updates a password counter, displays a warning that indicates the last password was invalid, and returns to step 510 in order to receive another password from the user. However, if computer system 100 determines that more than the threshold number of invalid passwords have been entered, then computer system 100 in step 524 displays a warning message that indicates the password was invalid, and disables use of computer system 100. To this end, computer system 100 in an exemplary embodiment invokes execution of a system shutdown process that causes computer system 100 to terminate execution of all executing processes.

The Microsoft™ Windows™ environment provides various utility programs for setting system clock 126. A user could potentially circumvent the protection of the payment assurance application by setting system clock 126 backwards via these configuration utilities. Whenever one of the Microsoft™ Windows™ utility programs changes system clock 126, a Microsoft™ Windows™ API message is generated which informs other applications of the change to system clock 126. Accordingly, if computer system 100 in step 504 determined based upon the date stamp that system clock 126 had not been set backwards, then computer system 100 in step 526 further determines whether system clock 126 had been changed based upon Microsoft™ Windows™ API messages generated by the configuration utilities.

If computer system 100 determines in step 526 that system clock 126 has changed, then computer system 100 in step 528 displays a warning that indicates changes to system clock 126 are prohibited. Computer system 100 then in step 530 determines whether the system clock has been set backwards by more than a threshold amount (e.g. 15 minutes) within a predetermined period (e.g. 24 hours). To this end, computer system 100 determines whether the time difference between the current system time as indicated by system clock 126 and the last confirmed system time is greater than the threshold amount remaining for the predetermined period.

If computer system 100 in step 530 determines that system clock 126 has been set backwards by more than the threshold amount within the predetermined period, then computer system 100 proceeds to step 508 in order to display a warning and receive a password from the user. However, if computer system 100 determines that system clock 126 has not been set backwards by more than the threshold amount within the predetermined period, then computer system 100 in step 532 updates the threshold amount remaining for the predetermined period and exits monitoring method 500 until the next periodic execution of monitoring method 500. To this end, computer system 100 in an exemplary embodiment subtracts the time difference from the threshold amount remaining, encrypts the obtained difference, and stores the encrypted difference in a non-volatile manner. More specifically, computer system 100 stores the encrypted difference in a key of the Registry Database for future access by computer system 100.

After verifying the payment assurance application will be invoked upon system startup and system clock 126 has not been changed by the user, computer system 100 in step 533 updates the confirmed system time to the system time indicated by system clock 126. More specifically, computer system 100 in an exemplary embodiment updates the confirmed system time in a persistent manner by storing the system time in a key of the Registry Database.

Computer system 100 then in step 534 determines whether the date stamp associated with the payment assurance application needs to be updated. In particular, if the confirmed system time indicates a date later than the date stamp for the payment assurance application, then computer system 100 in step 535 updates the date stamp for the payment assurance application. More specifically, computer system 100 in an exemplary embodiment updates the data stamp by storing the date indicated by the confirmed system time on mass storage device 118 in a header portion of an executable file used to implement the payment assurance application.

In step 536, computer system 100 resets the time amount remaining for the predetermined period and the pre-notification counter. In an exemplary embodiment, computer system 100 provides a pre-notification warning once each day computer system 100 is within a pre-notification period. Accordingly, by resetting the pre-notification counter upon determining the date has changed ensures that the pre-notification warning message is displayed only once a day. Similarly, computer system 100 in an exemplary embodiment allows system clock 126 to be set backwards by no more than a threshold amount within a predetermined period of a day. Accordingly, resetting the time amount remaining upon determining that the date has changed ensures that system clock 126 may be set backwards by the threshold amount each predetermined period. The predetermined period and the pre-notification period may be implemented with separate and different time intervals. Furthermore, those skilled in the art in light of the description herein may implement other time intervals for the predetermine period and the pre-notification using known techniques and without undue experimentation.

Computer system 100 then in step 537 determines whether the grace period has passed. To this end, computer system 100 determines based upon the entered payment password, the stored payment schedule information, and system clock 126 whether the grace period has passed. For example, if the stored payment schedule information defines monthly payments due on the 1^{st} of each month and a 10 day grace period, then computer system 100 would determine the grace period had passed in response to the user entering the correct payment password for March 1999 and system clock 126 indicating the date as Apr. 11, 1999. If computer system 100 determines that the grace period has passed, then computer system 100 in step 538 displays a warning message that indicates the current installment period is past due and provides contact information of the organization to which payment is to be made. After displaying the warning message for a few seconds, computer system 100 in step 540 disables use of computer system 100.

If computer system determines in step 537 that the grace period has not yet passed, then computer system 100 in step 542 determines whether the grace period has been entered. To this end, computer system 100 determines based upon the entered payment password, the stored payment schedule information, and system clock 126 whether the grace period has been entered. For example, if the stored payment schedule information defines weekly payments due on Sunday of each week and a 10 day grace period, then computer system 100 would determine the grace period had been entered in response to the user entering the correct payment password for the week beginning Sunday, Oct. 10, 1999 and system clock 126 indicating the date as Oct. 18, 1999. If computer system 100 determines that the grace period has been entered, then computer system 100 in step 544 displays a warning message that indicates the current periodic payment is past due and provides contact information for the organization to which payment is to be made.

However, if computer system 100 determines that the grace period has not been entered, then computer system 100 in step 546 determines whether the pre-notification period (e.g. 3 days before payment due date) has been entered. To this end, computer system 100 determines based on the entered payment password, the stored payment schedule information, and system clock 126 whether the pre-notification period has been entered. For example, if the stored payment schedule information defines monthly payments due on the first of each month and a 3 day pre-notification period, then computer system 100 would determine that the pre-notification period had been entered in response to the user entering the correct password for the month of September and system clock 126 indicating the date as Sep. 30, 1999.

If computer system 100 determines that the pre-notification period has been entered, then computer system 100 in step 548 determines based upon a pre-notification counter and system clock 126 whether a pre-notification warning message has been displayed for the current date. If computer system 100 determines that the pre-notification warning has already been displayed for the current date, then computer system 100 exits the monitoring method until the next periodic execution of monitoring method 500. However, if computer system 100 determines that the pre-notification warning has not been displayed for the current date, then computer system 100 in step 550 displays a warning message that indicates the date by which the next periodic payment is due. Computer system 100 then in step 552 updates the pre-notification counter in order to prevent the pre-notification warning from being displayed again for the current date.

Since computer system 100 executes monitoring method 500 on a periodic basis, computer system 100 in an exemplary embodiment causes the grace period warning to be displayed each time computer system 100 periodically executes monitoring method 500. If computer system 100 is configured to execute monitoring method 500 on a relatively short interval such as 500 millisecond, then the computer system 100 will essentially cause the grace period warning to be continually displayed once the grace period is entered. It should be appreciated, however, that the grace period warning may be implemented in a less intrusive manner similar to the pre-notification warning by utilizing a grace period counter that causes the grace period message to be displayed less frequently such as once a day, once an hour, or once every 15 minutes.

A program removal method 600 is illustrated in FIG. 6. In general, computer system 100 executes the program removal method 600 in response to receiving the payment password for the last payment period. As depicted in FIG. 6, computer system 100 in step 602 re-enables mechanisms which were previously disabled in order to prevent the user from removing the payment assurance application from computer system 100. More specifically, computer system 100 in an exemplary embodiment re-enables the MS-DOS format command. To this end, computer system 100 un-encrypts the format command, renames the format command to its standard filename, and stores the un-encrypted and properly named format command in its standard location on mass storage device 118.

In step 604, computer system 100 removes stored configuration information for the payment assurance application from computer system 100. In particular, computer system 100 removes the password lists, the payment schedule information, the confirmed system time information, and mechanisms for ensuring execution of the payment assurance application upon startup. More specifically, computer system 100 in an exemplary embodiment removes the references to the payment assurance application from the “Run” and “RunOnce” keys of the Registry Database. Furthermore, computer system 100 in the exemplary embodiment removes all other keys of the Registry Database associated with the payment assurance applications such as keys used to store the password lists, confirmed system time, and payment schedule information.

Computer system 100 then in step 606 removes all files associated with the payment assurance application from computer system 100. In an exemplary embodiment, computer system 100 essentially deletes the executable file used to implement the payment assurance application from mass storage device 118.

After removing the configuration information and files associated with the payment assurance application, computer system 100 in step 608 invokes a reboot operation in order to cause computer system 100 to terminate all executing processes and to complete the removal of the payment assurance program from computer system 100.

Exemplary Embodiment B

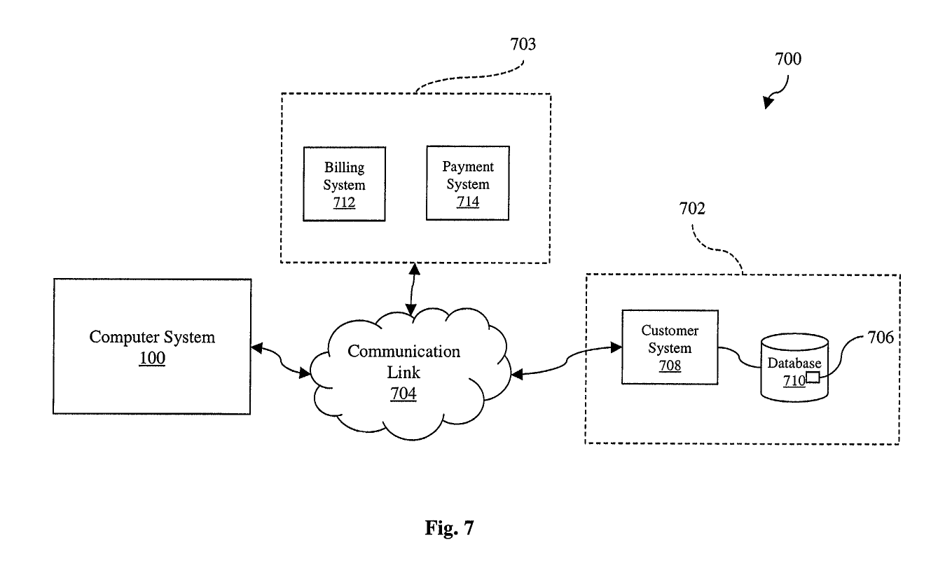

As shown in FIG. 7, in a second exemplary embodiment, computer system 100 executes a second exemplary embodiment of a payment assurance application 700. Payment assurance application 700, like the payment assurance application of exemplary embodiment A is configured to encourage timely payments by a customer for use of computer system 100 by enabling use of computer system 100 if it is determined that the customer has made a proper payment to a vendor associated with computer system 100 or otherwise has a credit associated with computer system 100. Example vendors include computer manufacturers, wholesalers, and retailers. If a timely payment has not been made by the customer, then payment assurance application 700 disables the use of computer system 100 until a timely payment has been made to the vendor.

In exemplary embodiment A, a plurality of passwords were created to correspond to various payment periods and the customer was required to supply the correct password for the current payment period to gain access to computer system 100. As explained in more detail below, in exemplary embodiment B, a shutoff value is determined and provided to computer system 100. The shutoff value is based upon payments received from the customer or other credits associated with computer system 100. Computer system 100 compares the shutoff value to a current value of computer system 100, such as a value of system clock 126, to determine whether to enable use of computer system 100. In one variation, if the current value is less than or equal to the shutoff value then computer system 100 is enabled for use by the customer. If the current value is greater than the shutoff value than computer system 100 is disabled from use by the customer.

Referring to FIG. 7, an embodiment of exemplary embodiment B is shown. Computer system 100 is configured to communicate with a monitoring system 702 through a communication link 704, such as the Internet. Alternatively, the communication link is a local area network, a wide area network, an Intranet, and/or other wired or wireless networks.

Monitoring system 702 is configured to provide a shutoff value 706 to computer system 100 through communication link 704. Shutoff value 706, in one variation of exemplary embodiment B, corresponds to a date determined by the vendor which corresponds to the date for which payment from the customer or other credit has been received in connection to computer system 100. In alternative variations, the shutoff value is a time, a combination of a date and a time, or a code which corresponds to a date, a time, or a combination of a date and time. Computer system 100 is configured to receive shutoff value 706 and enable use or disable use of computer system 100 based upon the comparison of shutoff value 706 to a current value of computer system 100.

Monitoring system 702 includes a customer system 708 which is configured to communicate through communication link 704 with computer system 100 and with a vendor system 703. Customer system 708 is further configured to retrieve information associated with computer system 100 from a database 710. Database 710 includes information relating to computer system 100, the customer associated with computer system 100, corporate or individual, and the vendor associated with computer system 100. Database 710 further includes shutoff value 706 associated with computer system 100. Upon receiving a valid request, through communication link 704, or alternatively through another network, customer system 708 provides shutoff value 706 to computer system 100. Customer system 708 further keeps track of the number of times each computer system 100 connects to monitoring system 702 and requests a shutoff value 706 and records any tampering or other activities collected by payment assurance application 700 on computer system 100. Database 710 further includes information relating to vendor system 703.

Customer system 708 is further configured to receive and provide information to vendor system 703. In one embodiment, vendor system 703 further includes a billing system 712 which generates payment notices associated with computer system 100. The payment notices are sent to the customer associated with computer system 100 to inform him/her that a payment is due by a certain date. Payment notices are supplied to the customer via mail, e-mail, or some alternative mechanism. Billing system 712 is configured to retrieve the most current information associated with computer system 100 from database 710 through communication with customer system 708.

Billing system 712, in one embodiment, communicates with customer system 708 through a client utility. The client utility is accessible by the vendor who sold, leased or rented computer system 100 to the customer or a designee of the vendor. In one variation wherein the communication link 704 is the Internet, the client utility is a web site. Vendor system 703 supplies information to customer system 708 by posting information to the web site, such as by posting an Extensible Markup Language (XML) document to an active server page (ASP). Customer system 708 in response to the information posted by vendor system 703 updates information in database 710 and makes available information in database 710 concerning the vendor and the computer system 100 of interest.

In one variation of exemplary embodiment B, billing system 712 communicates with customer system 708 through communication link 704. In an alternate variation, the billing system communicates with the customer system through a local area network, a wide area network, an Intranet, and/or other wired or wireless networks. In further alternative variations, the billing system and customer system both are resident on the same computer which has access to the database.

Vendor system 703 further includes a payment system 714 which is configured to update database 710 when a payment or other credit or debit or other event associated with computer system 100 is processed. In one variation, vendor system 703 calculates a new shutoff value 706 based upon the amount of the credit or debit and the last known value of shutoff value 706. The new shutoff value 706 is provided to customer system 708 such that database 710 is updated correctly. Since the value of shutoff value 706 is in the control of the vendor, the vendor may establish a policy which permits the shutoff value to reflect partial payments as well as variable payment periods. In another variation, only payments associated with a full payment will be processed thereby maintaining a fixed payment period. The vendor may further establish a policy of allowing a grace period. For example, the vendor would calculate the new shutoff value 706 to include a grace period and provide customer system 708 with a message to be provided to computer system 100 indicating that the grace period has been entered and that payment is required.

In one variation of exemplary embodiment B, payment system 714 communicates with customer system 708 through communication link 704. In alternative variations, the payment system communicates with the customer system through a local area network, a wide area network, an Intranet, and/or other wired or wireless networks. In a further alternative variation, the payment system and customer system both are resident on the same computer which has access to the database.

Payment system 714 communicates with customer system 708 through a client utility. The client utility is accessible by the vendor who sold, leased or rented computer system 100 to the customer or a designee of the vendor, such as a third party contracted by the vendor to handle billings and payments associated with computer system 100. In one variation wherein the communication link 704 is the Internet, the client utility is a web site. Payment system 714 supplies shutoff value 706 to customer system 708 by posting information to the web site, such as by posting a XML document to an ASP. Customer system 708 in response to the information posted by vendor system 703 updates information in database 710 and makes available information in database 710 concerning the vendor and the computer system 100 of interest.

In one embodiment computer system 708 has two levels of password protection associated with the client utility. A first level allows access to customer system 708 by an employee of the vendor whose main purpose is to use the application to update shutoff values 706 associated with computer systems 100. In one variation, access to the first level allows the employee to update a customer's shutoff value, display customer information such as the number of dial-ups, tamper attempts, etc. create new customers, including an initial shutoff value, and change the password associated with employee login. A second level allows access to customer system 708 by a vendor administrator whose privileges allow them to monitor the employee's usage at the first level. In one variation, access to the second level, allows the administrator all the capabilities of the first level and to create new client logins and passwords, to create new administrator logins and passwords, view activity of employees, view employee usage logs, generate reports, and reset passwords.

By having two levels of password access, customer system 708 further provides security for multiple users and administrators. In one variation, customer system 708 provides protection so that only a single employee can edit a customer record in database 710 at a given time. Further, customer system 708 allows the vendor to set status flags associated with computer system 100, such as the date the vendor determined a new shutoff value 706, the date that an upgrade or new version of payment assurance application 700 was downloaded to computer system 100 and if a rent to own type arrangement is in place the date associated with a release date. The release date corresponding to the date when the customer's account will be fully paid. Customer system 708 also provides the mechanism to generate either general or specific messages to computer system 100. The general and specific messages are stored in database 710 or a pointer is inserted in database 710 pointing to the location of the messages.

In another embodiment, customer system 708 includes a mass update utility which permits a user, such as a user having access to the first password level of customer system 708, to upload a document to customer system 708 which includes information pertaining to several customer accounts. In one variation, the document is a specially formatted Excel spreadsheet which has one column of customer numbers, each number relating to a computer system 100, and a column of data reflecting what action needs to be taken with respect to the computer system 100. An example action is providing a new shutoff value.

Monitoring system 702, in one embodiment, further includes a utility which permits the company which supplies computer systems to a number of vendors, such as a computer manufacturer, to perform all client administrative functions related to each vendor and/or each customer. The utility further allows the company to monitor system usage for each vendor and customers of each vendor.

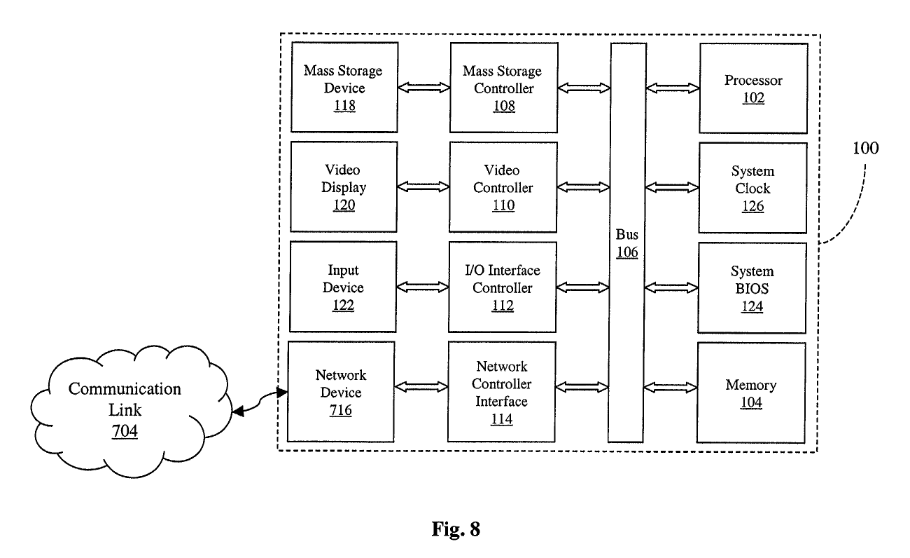

Referring to FIG. 8, computer system 100, in exemplary embodiment B, includes a network device 716 coupled to network controller interface 114. As stated in connection with exemplary embodiment A, network controller interface 114 provides processor 102 with an interface to devices coupled to communication 704, such as a LAN or the Internet. In one variation of exemplary embodiment B, network device 716 is a modem card, such as an analog modem, connecting processor 102 to the Internet through an Internet Service Provider (ISP). In another variation of exemplary embodiment B, network device 716 is a network card, such as an Ethernet card, connecting processor 102 to a LAN. The LAN may further be connected to the Internet. In alternative variations, the network device is a ISDN modem, a cable modem, a general network card, a cellular modem, a wireless network card, and/or other wired/wireless communication devices.

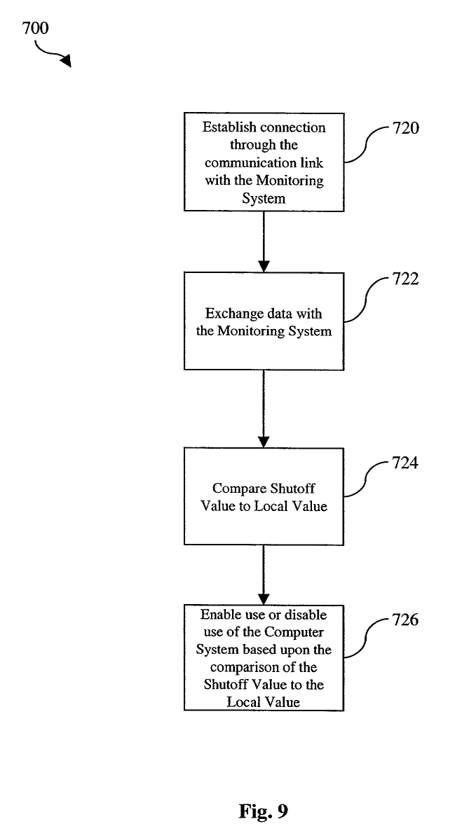

Referring to FIG. 9, an embodiment of payment assurance application 700 is shown. Payment assurance application 700 establishes a connection through communication link 704 with monitoring system 702, as represented in block 720; exchanges data with monitoring system 702 including receiving shutoff value 706 from monitoring system 702, as represented in block 722; compares shutoff value 706 to a current value of computer system 100, as represented by block 724; and either enables use or disables use of computer system 100 based upon the comparison of shutoff value 706 to the current value, as represented by block 726.

Payment assurance application 700 is installed on computer system 100. In one variation, payment assurance application 700 is installed on computer system 100 in a method generally similar to the installation method of the payment assurance application of exemplary embodiment A, shown in FIG. 2. Once installed on computer system 100, payment assurance application 700, functions similar to the payment assurance application of exemplary embodiment A to prevent the unauthorized circumventing of payment assurance application 700. In one variation, payment assurance application 700, is launched during system startup and is maximized to cover the whole screen. Further a Windows™ API call is set lead Windows™ into thinking that a screen saver is running.

In another variation, a second application is included on computer system 100 along with payment assurance application 700. The second application is launched from payment assurance application 700 and is configured to set itself up in the registry of computer system 100 such that when an executable is to be launched on computer system 100 it is launched through the second application. For example, when the user tries to launch Excel, the Excel executable will be launched by the second application. As such, before launching Excel, the second application checks to see if payment assurance application 700 is still running. If it is not, then the second application launches payment assurance application 700. If payment assurance application 700 cannot be launched then the second application prohibits the launching of Excel.

Additionally, payment assurance application 700 monitors, similar to the payment assurance application in exemplary embodiment A, whether the user of computer system 100 has tried to alter the time or date of system clock 126. In one variation, payment assurance application records the date and time of system clock 126 when computer system 100 is shutdown and compares that value to the value of system clock 126 when computer system 100 is restarted to ensure that the current value is later in time than the stored value from shutdown. In another variation, a stopwatch type feature is included in payment assurance application 700. At a time A, the value of system clock 126 is recorded. At a time B, which is “x” minutes later than time A, a second value of system clock 126 is stored. Assuming the value of system clock 126 has not been changed by the user subtracting “x” from the value recorded at time B should result in the value recorded at time A.

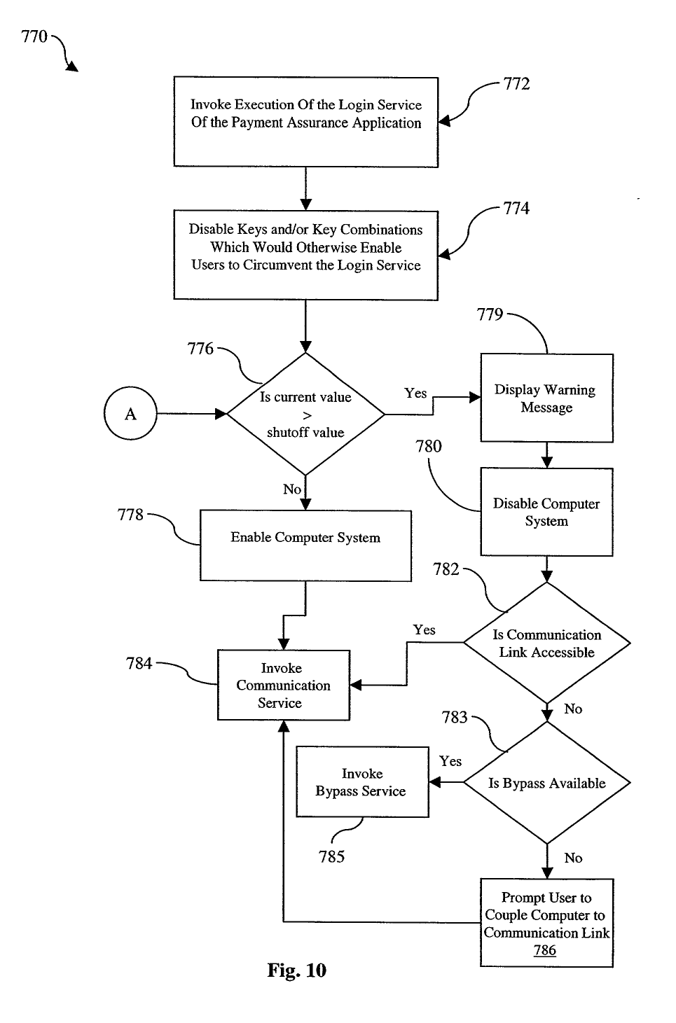

Referring to FIG. 10, an exemplary login service 770 of payment assurance application 700 is shown. After being configured with payment assurance application 700, computer system 100 automatically executes login service 770 as part of the startup process of computer system 100, as represented by block 772. Login service 770 causes computer system 100 to disable certain keys and/or key conditions of the keyboard which would enable a user to switch to another process or permanently terminate payment assurance application 700, as represented in block 774. For example, in the Microsoft™ Windows™ environment, the exemplary assurance application causes the computer system 100 to disable the “Alt-Tab”, “Ctrl-Esc”, “Alt-F4”, and “Ctrl-Alt-Delete” keys and/or key combinations which may otherwise enable users to circumvent the login service of the payment assurance application by causing computer system 100 to switch to another executing process or causing computer system 100 to prematurely terminate the execution of the payment assurance application.

Login service 770 next compares a current value of computer system 100 to a locally stored shutoff value, as represented by block 776, the locally stored shutoff value corresponding to the last shutoff value 706 received from monitoring system 702. If the current value is less than or equal to the locally shared shutoff value computer system 100 is enabled, as represented by block 778, and a communication service 741 is invoked, as represented by block 784. If the current value is greater than the shutoff value, a warning message is displayed, as represented by block 779, and computer system 100 is disabled pending the reception of a new shutoff value, as represented by block 780. In one variation, computer system 100 is disabled by preventing access to the operating system of computer system 100.

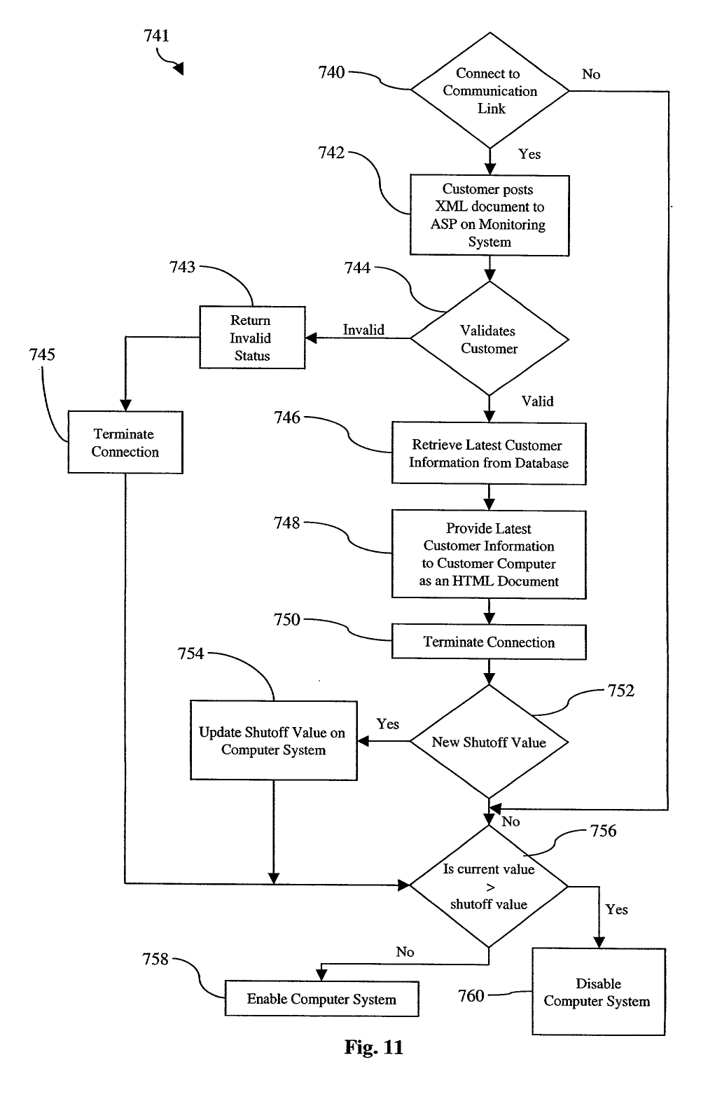

If computer system 100 is disabled, login service 770 next determines if communication link 704 is currently accessible, as represented by block 782. As represented by block 784, if communication link 704 is accessible, computer system 100 invokes communication service 741, shown in FIG. 11, which attempts to retrieve the latest shutoff value associated with computer system 100 from monitoring system 702. If communication link 704 is not accessible, login service 770 checks to determine if bypass service 800 is available, as represented by block 783. If bypass service 800 is available, then bypass service 800 is invoked, as represented by block 785 and explained in more detail below. If bypass service 800 is not available, then login service 770 prompts the user to couple computer system 100 to communication link 704, as represented by block 786.

Turning to FIG. 11, the interaction between payment assurance application 700 on computer system 100 and monitoring system 702 in a preferred variation of communication service 741 is shown. As represented in block 740, computer system 100 attempts to establish a connection to communication link 704. If a connection is established, computer system 100 communicates with monitoring system 702, as represented by block 742. If computer system 100 is unable to establish a connection to communication link 704, then the current value of computer system 100 is compared to shutoff value 706, as represented by block 756 and explained in more detail below.

In one variation, computer system 100 detects that network device 716 is connected to communication link 704 and uses that detected connection to communicate with monitoring system 702. For example, wherein communication link 704 is the Internet and computer system 100 is connected to the Internet through an Internet account associated with the user with an Internet Service Provider (ISP), computer system 100 detects that connection and uses that connection to communicate with monitoring system 702. For additional example, wherein communication link 704 is the Internet and computer system 100 is connected to a LAN that includes a server connected to the Internet, computer system 100 detects that connection and uses that connection to communicate with monitoring system 702.

In another variation, payment assurance application 700 includes connection settings for a pre-arranged account with an ISP so that computer system 100 can use network device 716, shown in FIG. 8, to establish a connection with communication link 704 regardless of whether the user of computer system 100 has a personal account that connects with communication link 704, as in the prior variations. For example, wherein communication link 704 is the Internet, the vendor has an account setup with an ISP and supplies the required connection settings to payment assurance application 700 so that when the user of computer system 100 couples a transmission media, such as a phone line, to network device 716 computer system 100 detects the connection, connects to the ISP and uses the connection with the ISP to communicate with monitoring system 702.

Returning to FIG. 11, computer system 100 provides information to monitoring system 702 by posting an Extensible Markup Language (XML) document to an Active Server Page (ASP) associated with monitoring system 702, as represented by block 742. Alternatively, the computer system provides information to the monitoring system by including the information in a query string associated with a Uniform Resource Locator (URL) address. In one variation, computer system 100 provides to monitoring system 702 the customer number associated with computer system 100, the number of tamper attempts (relating to files and the system clock time), the version of payment assurance application 700 currently residing on computer system 100, whether the connection to communication link 704 was established by the pre-packaged ISP account or not, and the length of time of the prior connection to monitoring system 702.

Monitoring system 702 receives the information supplied by computer system 100 and determines whether the information corresponds to a valid customer, as represented in block 744. In one variation, monitoring system 702 compares the supplied customer number with a list of customer numbers stored in database 710. If the information does not correspond to a valid customer, monitoring system 702 returns an invalid status to computer system 100, as represented by block 743. In one variation, if an invalid status is returned, payment assurance application 700 displays a message informing the user that an invalid status has been received. Monitoring system 702 next terminates the connection between monitoring system 702 and computer system 100, as represented by block 745. Payment assurance application then determines if computer system 100 should be enabled for use or disabled for use, as represented in block 756 and explained in more detail below.

If monitoring system 702 determines that the information supplied by computer system 100 corresponds to a valid customer, monitoring system 702 retrieves the current customer information from database 710, as represented by block 746. In one variation the current customer information includes any messages from monitoring system 702, such as general messages like “Happy New Year,” or possible promotions or specific messages like “Thank you for prompt payment,”; whether a new version of payment assurance application 700 is available; a value for the current date and time as known by monitoring system 702; and the current shutoff date 706.

Once the information is retrieved from database 710, at least a portion of the retrieved information or information related to the retrieved information is provided to computer system 100, as represented by block 748. In a preferred variation, the information provided to computer system 100 by monitoring system 702 consists of a Hyper Text Markup Language (HTML) document including a text string having individual pieces of information separated by a specific character, such as the pipe character “|”.

In one variation, computer system 100 checks the current date and time provided by a third party, such as the atomic clock maintained by the United States government in Boulder, Colo.

In one variation, wherein a new version of payment assurance application 700 is available, monitoring system 702 supplies to computer system 100 shutoff date 706, a value for the current date and time as known by monitoring system 702, any messages, and information concerning the location of the new version of payment assurance application 700. In one example, monitoring system 702 provides file transfer protocol (ftp) information relating to the new version to computer system 100. In one variation the new version is automatically provided to computer system 100. In another variation the customer is prompted through computer system 100 whether he wants to download the new version of the payment assurance application 700 during the current connection.

Once the information from monitoring system 702 has been provided to computer system 100, the connection between monitoring system 702 and computer system 100 is terminated, as represented by block 750. In cases wherein computer system 100 established the connection to communication link 604 through a pre-packaged account provided by the vendor, such as an ISP account, termination of the connection between monitoring system 702 and computer system 100 results in the termination of the connection between computer system 100 and communication link 704. As such, the pre-packaged account is used solely for communication with monitoring system 702. In all other cases, the connection between communication link 704 and computer system 100 remains intact.

Payment assurance application 700 retrieves the new shutoff value 706 from the information provided from monitoring system 702. Shutoff value 706 is compared to a locally stored shutoff value, which is the prior shutoff value retrieved from monitoring system 702, to determine if a new shutoff value was provided by monitoring system 702, as represented in block 752. Alternatively, the monitoring system provides a new shutoff value only when there has been a change in the shutoff value relating to the computer system since the last communication with the computer system. As such, the payment assurance application checks to see if a new shutoff value was provided by the monitoring system to determine if it needs to make a comparison with the locally stored shutoff value on the computer system.

If shutoff value 706 is different than the locally stored shutoff value, the value of the locally stored shutoff value is replaced with shutoff value 706, as represented by block 754. Shutoff value 706 in one variation is greater than the locally stored shutoff value, the prior shutoff value retrieved from monitoring system 702, indicating that a payment or other credit has been associated with computer system 100. Shutoff value 706 in another variation is less than the locally stored shutoff value indicating that debit, such as insufficient funds associated with a check, has been associated with computer system 100.

If shutoff value 706 is the same as the locally stored shutoff value or if the locally stored shutoff value has been updated to equal shutoff value 706, payment assurance application 700 then compares the locally stored shutoff value to a current value of computer system 100, represented by block 756. In one variation shutoff value 706 corresponds to a shutoff date and payment assurance application compares the shutoff date to a current date value which corresponds to the date of system clock 126. In this variation, payment assurance application 700 compares to see if the date associated with system clock 126 is greater than, equal to or less than shutoff value 706. In alternate variations, the shutoff value corresponds to a time or a date and time and the current value corresponds to a time of the system clock or a date and time of the system clock.

If the current value is less than or equal shutoff value 706, payment monitoring system 700 enables computer system 100, as represented by block 758. In one variation, payment monitoring system 700 enables access to the operating system of computer system 100. If the current value is greater than shutoff value 706, payment monitoring system 700 disables computer system 100, as represented by block 760. In one variation, payment monitoring system 700 disables access to the operating system of computer system 100.

In one variation, payment assurance application 700 displays notification messages on computer system 100 corresponding to a notification period, if the notification period has been entered. An example message would include the number of days left before a payment is past due. In one variation, payment assurance application 700 is configured to provide an icon in the system tray which indicates the number of days or units of time left before payment is due. For example, if more than five days are left the icon is green, if less than five days are left the icon is yellow, and if less than three days are left the icon is red.

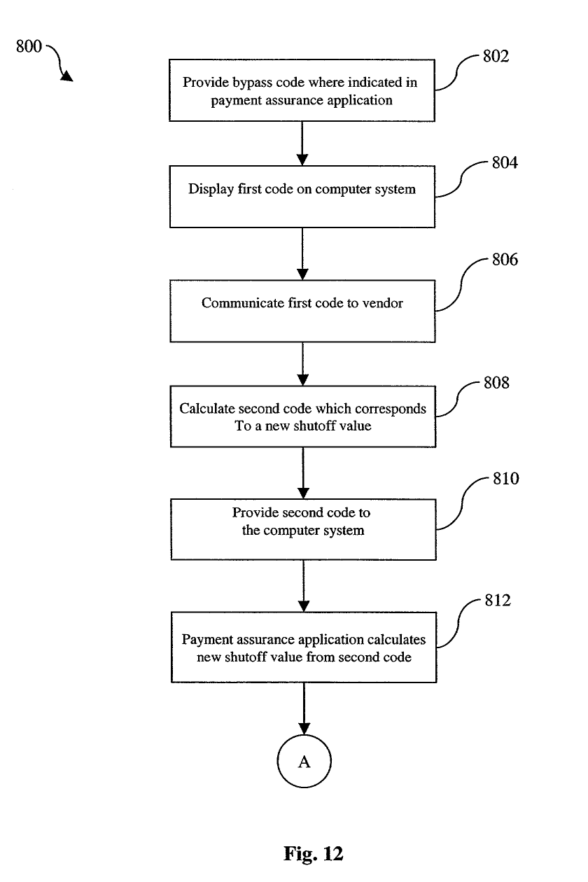

Referring to FIG. 12, an exemplary embodiment of bypass service 800 is shown. Bypass service 800 is a service whereby when the customer cannot connect to communication link 704, the customer may still obtain a new shutoff value. Payment assurance application 700 provides the user of computer system 100 with an entry box wherein a code is entered. The entry box may be used to supply payment assurance application with the customer number associated with computer system 100 or a user name. The user may also enter a bypass code in the entry box, as represented by block 802.

Payment assurance application 700 is configured to provide a first code when a bypass code is entered in the entry box, as represented by block 804. In one variation the first code is a five digit number. The bypass code is either coded into payment assurance application 700 or stored in memory 104 or mass storage device 118 of computer system 100. In one example, the bypass code is the word “magic”. Each computer system 100 may have a different bypass code or all computer systems 100 may have the same bypass code.

The customer then provides the first code to the vendor, as represented in block 806. In one example, the customer places a phone call to the vendor. The vendor then calculates a second code which corresponds to a new shutoff value 706, as represented by block 808. In a preferred variation, the vendor accesses customer system 708, see FIG. 7, through communication link 704 and provides customer system 708 with the first code received from the user, the customer number associated with the user and a requested value corresponding to increase in the shutoff value. In one example, the shutoff value 706 may be increased from one to sixty days. Customer system then using a predetermined algorithm calculates the second code based upon the supplied values for the first code, the customer number and the requested value. The second code is provided to the vendor.

The vendor then provides the second code to the customer, as represented by block 810. The customer then enters the second code in the entry box provided by the payment assurance application 700. Payment assurance application 700 decodes the second code with an algorithm based upon the algorithm used by the customer system 708. As such, given the second code, the customer number and the first code, payment assurance application 700 can calculate the new shutoff date 706, as represented by block 812. Once the new shutoff date 706 has been calculated, payment assurance application 700, returns to block 776 of the login service to determine if the current value of computer system 100 is greater than, equal to, or less than the new shutoff value 706.

While the invention has been illustrated and described in detail in the drawings and foregoing description, such illustration and description is to be considered as exemplary and not restrictive in character, it being understood that only exemplary embodiments have been shown and described and that all changes and modifications that come within the spirit of the invention are desired to be protected. For example, the exemplary embodiment A of the payment assurance application automatically removes itself from the computer system 100 upon entering the password associated with the last payment which is advantageous for purchase-over-time agreement. However, the payment assurance application of exemplary embodiment A may be implemented to automatically disable the computer system 100 after the last day of the payment schedule which may be advantageous for lease arrangements where the user is to return the computer system 100 at the termination of the lease.

I claim:

1. A method of encouraging payments associated with a computer system, the method comprising the steps of:
providing to the computer system current customer information from a database, the current customer information including a shutoff value;
comparing the shutoff value and a current value of the computer system; and
enabling use of the computer system if the current value of the computer system is less than the shutoff value.

2. The method of claim 1, further comprising the step of:
disabling use of the computer system if the current value is greater than the shutoff value.

3. The method of claim 2, wherein the step of disabling use of the computer system includes not allowing access to an operating system of the computer system.

4. The method of claim 1, wherein the shutoff value includes a shutoff date and the current value includes a current date.

5. The method of claim 1, wherein the current value is determined from a system clock of the computer system and wherein the method further comprises the steps of:
detecting whether the system clock of said computer system has been changed in an unauthorized manner; and
disabling the computer system based upon detecting the system clock has been changed in the unauthorized manner.

6. The method of claim 1, further comprising the steps of:
determining whether the computer system is within a pre-notification period corresponding to the shutoff value; and
displaying a warning message if the computer system is within a pre-notification period corresponding to the shutoff value.

7. The method of claim 1, wherein the current customer information is provided in response to a request for the current customer information from the computer system, the request being initiated by the computer system when a connection between the computer system and the communication link is established.

8. The method of claim 7, wherein the communication link is the Internet and the request includes a document being sent to an active server page.

9. The method of claim 8, wherein the document sent to the active server page is an extensible markup language document.

10. The method of claim 7, wherein the communication link is the Internet and the computer system includes a pre-packaged account with an Internet Service Provider for establishing the connection between the computer system and the communication link.

11. The method of claim 7, wherein general and specific messages are provided to the computer system in the current customer information.

12. The method of claim 1, wherein the current value of the computer system is compared to the shutoff value during a system startup process of the computer system.

13. A computer readable medium for encouraging payments associated with a computer system, the computer readable medium comprising a plurality of instructions which when executed by the computer system cause the computer system to:
compare a retrieved shutoff value and a current value of the computer system, the shutoff value being based upon a credit associated with the computer system and the current value being based upon a system clock of the computer system; and
enable use of the computer system based upon determining that the retrieved shutoff value is greater than the current value.

14. The computer readable medium of claim 13, wherein the plurality of instructions when executed by the computer system further cause the computer system to:
disable use of the computer system if the shutoff value is less than the current value.

15. The computer readable medium of claim 14, wherein the step of disabling use of the computer system includes not allowing access to an operating system of the computer system.

16. The computer readable medium of claim 13, wherein the plurality of instructions when executed by the computer system further cause the computer system to:
detect whether the system clock of the computer system has been changed in an unauthorized manner; and
disable use of the computer system based upon detecting that the system clock has been changed in the unauthorized manner.

17. A method of establishing a usage period associated with a computer system for a user, comprising the steps of:
notifying the user that a payment associated with the computer system is due by a first shutoff value;
receiving a second shutoff value;
providing the second shutoff value to the computer system through a communication link; and
enabling use of the computer system if a current value of the computer system is less than the second shutoff value.

18. The method of claim 17, further comprising the step of:
disabling use of the computer system if the current value of the computer system is greater than the second shutoff value.

19. The method of claim 18, wherein the step of disabling use of the computer system includes not allowing access to an operating system of the computer system.

20. The method of claim 17, wherein the current value corresponds to the value of a system clock of the computer system and wherein the method further comprises the steps of:
detecting whether the system clock of the computer system has been changed in an unauthorized manner; and
disabling the computer system based upon detecting the system clock has been changed in the unauthorized manner.

21. The method of claim 17, wherein the second shutoff value is retrieved from a vendor which provided the computer system to the user and wherein the second shutoff value corresponds to a credit or debit being associated with the computer system.

22. The method of claim 21, wherein the second shutoff value is provided to the computer system in response to a request from the computer system, the request being initiated by the computer system when a connection between the computer system and the communication link is established.

23. The method of claim 22, wherein the communication link is the Internet and the request includes a document being sent to an active server page.

24. The method of claim 17, further comprising the steps of:
storing the second shutoff value in a database; and
receiving a request for the second shutoff value from the computer system through the communication link.

25. A method of encouraging payments associated with a computer system, the method comprising the steps of:
providing to the computer system current customer information from a database, the current customer information including a shutoff value, which is based upon at least one credit associated with the computer system;
comparing the shutoff value to a current value of the computer system; and
enabling use of the computer system based upon the comparison of the current value and the shutoff value.

26. The method of claim 25, wherein the computer system is enabled if the current value of the computer system is less than the shutoff value and wherein the computer system is disabled if the current value of the computer system is greater than the shutoff value.

27. The method of claim 26, wherein the computer system is disabled by not allowing access to an operating system of the computer system.

28. The method of claim 25, wherein the shutoff value includes a shutoff date and the current value includes a current date.

29. The method of claim 25, wherein the current value is determined from a system clock of the computer system and wherein the method further comprises the steps of:
detecting whether the system clock of said computer system has been changed in an unauthorized manner; and
disabling the computer system based upon detecting the system clock has been changed in the unauthorized manner.

30. The method of claim 25, further comprising the steps of:
determining whether the computer system is within a pre-notification period corresponding to the shutoff value; and
displaying a warning message if the computer system is within a pre-notification period corresponding to the shutoff value.

31. The method of claim 25, wherein the current customer information is provided in response to a request for the current customer information from the computer system, the request being initiated by the computer system when a connection between the computer system and the communication link is established.

32. The method of claim 31, wherein the communication link is the Internet and the request includes a document being sent to an active server page.

33. The method of claim 32, wherein the document sent to the active server page is an extensible markup language document.

34. The method of claim 31, wherein the communication link is the Internet and the computer system includes a pre-packaged account with an Internet Service Provider for establishing the connection between the computer system and the communication link.

35. The method of claim 25, wherein the current value of the computer system is compared to the shutoff value during a system startup process of the computer system.
